(19) United States
(12) Patent Application Publication
(10) Pub. No.: US 2026/0143460 A1
(43) Pub. Date: May 21, 2026

(54) INACTIVE/IDLE MOBILITY ENHANCEMENTS BASED ON PREDICTED TRAJECTORY

(71) Applicant: InterDigital Patent Holdings, Inc., Wilmington, DE (US)

(72) Inventors: Oumer Teyeb, Montreal (CA); Brian Martin, Farnham (GB); Dylan Watts, Montreal (CA); Yugeswar Deenoo Narayanan Thangaraj, Chalfont, PA (US)

(73) Assignee: InterDigital Patent Holdings, Inc., Wilmington, DE (US)

(21) Appl. No.: 18/902,305

(22) Filed: Sep. 30, 2024

(51) Int. Cl. H04W 64/00; H04W 76/27

(52) U.S. Cl. CPC H04W 64/006; H04W 76/27

(57) ABSTRACT

A device (e.g., a wireless transmit/receive unit (WTRU)) may be configured to perform one or more actions for inactive/idle mobility enhancement based on predicted trajectory. For example, a device may send a predicted trajectory associated with the device. The device may receive configuration information comprising a margin of error associated with a validity of the predicted trajectory. The device may enter a radio resource control (RRC) inactive state based on an indication to transition from an RRC connected state to the RRC inactive state. The device may determine, in the RRC inactive state, a deviation from the predicted trajectory. The device may determine the deviation is not within the margin of error. The device may send an indication (e.g., a resume request) based on the determination that the deviation is not within the margin of error.

### BACKGROUND

Mobile communications using wireless communication continue to evolve. A sixth generation may be referred to as 6G. A fifth generation may be referred to as 5G. A previous (e.g., legacy) generation of mobile communication may be, for example, fourth generation (4G) long term evolution (LTE).

### SUMMARY

Systems, methods, and instrumentalities are described herein related to inactive/idle mobility enhancements based on predicted trajector(ies).

An example device may include a processor configured to perform one or more actions. For example, a device (e.g., a wireless transmit/receive unit (WTRU)) may send a predicted trajectory associated with the WTRU. The device may receive configuration information comprising a margin of error associated with a validity of the predicted trajectory. The device may enter a radio resource control (RRC) inactive state based on an indication to transition from an RRC connected state to the RRC inactive state. The device may determine, in the RRC inactive state, a deviation from the predicted trajectory. The device may determine the deviation is not within the margin of error. The device may send an indication (e.g., via a resume request message) based on the determination that the deviation is not within the margin of error. In examples, the resume request may comprise a cause value (e.g., a cause value that indicates a connection is being resumed for a trajectory update).

In examples, the device may receive an RRC resume message. The RRC resume message may indicate that a trajectory update is to be sent. The device may send the trajectory update that indicates one or more of: the deviation from the predicted trajectory; an updated trajectory; or an identity of the predicted trajectory.

In examples, the deviation may be a second deviation. The device may be (e.g., further) configured to determine a first deviation from the predicted trajectory. The device may determine that the first deviation is within the margin of error. The WTRU may remain in the RRC inactive state based on the determination that the first deviation is within the margin of error. In some examples, the device may refrain from performing a radio access network (RAN) update based on the determination that the first deviation is within the margin of error.

In examples, the device may be (e.g., further) configured to determine that the predicted trajectory has become invalid based on the determination that the deviation is not within the margin of error. The resume request may be sent based on the determination that the predicted trajectory has become invalid. In some examples, the device may send an indication that the predicted trajectory has become invalid.

In examples, the predicted trajectory may be a first predicted trajectory that may be associated with a first plurality of waypoints. The device may be (e.g., further) configured to determine a second predicted trajectory that is associated with a second plurality of waypoints. The device may compare the first plurality of waypoints with the second plurality of waypoints to determine the deviation from the first predicted trajectory. The device may determine a number of waypoints of the second plurality of waypoints that are different from the first plurality of waypoints. The determination that the deviation is not within the margin of error may be based on the number of waypoints being greater than a value.

In examples, the predicted trajectory may indicate that the WTRU is to traverse a first waypoint of the predicted trajectory at a first time. The device may be (e.g., further) configured to determine a probability for the WTRU to traverse the first waypoint at the first time. The determination that the deviation is not within the margin of error may be based on the probability being lower than a threshold.

In examples, the device may be (e.g., further) configured to determine the deviation from the predicted trajectory at a selected time interval.

In examples, the device may be (e.g., further) configured to indicate to a network that the WTRU is configured with a capability of predicting a trajectory associated with the WTRU. The device may determine the predicted trajectory associated with the WTRU. The predicted trajectory may be sent in a report to the network.

In examples, the configuration information may indicate the WTRU to transition from the RRC connected state to the RRC inactive state.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a state transition between INACTIVE and CONNECTED states.

### EXAMPLE NETWORKS FOR IMPLEMENTATION OF THE EMBODIMENTS

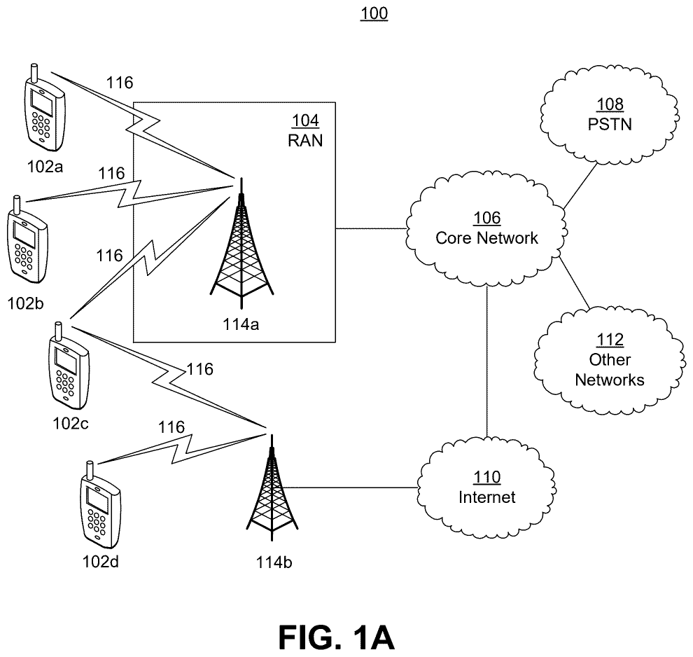

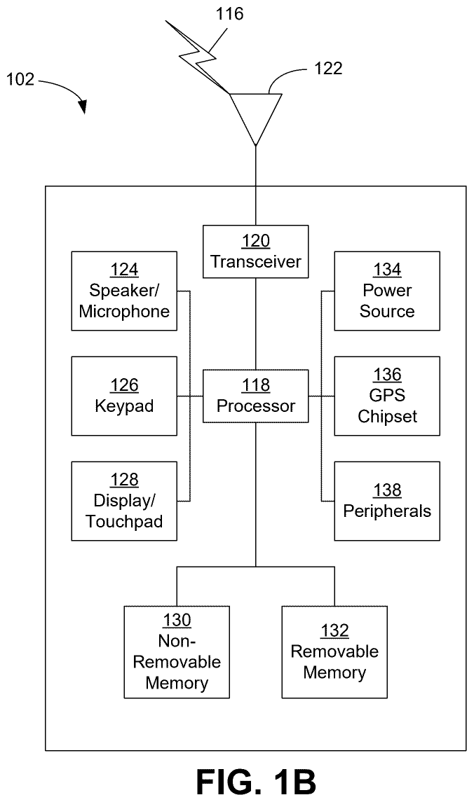

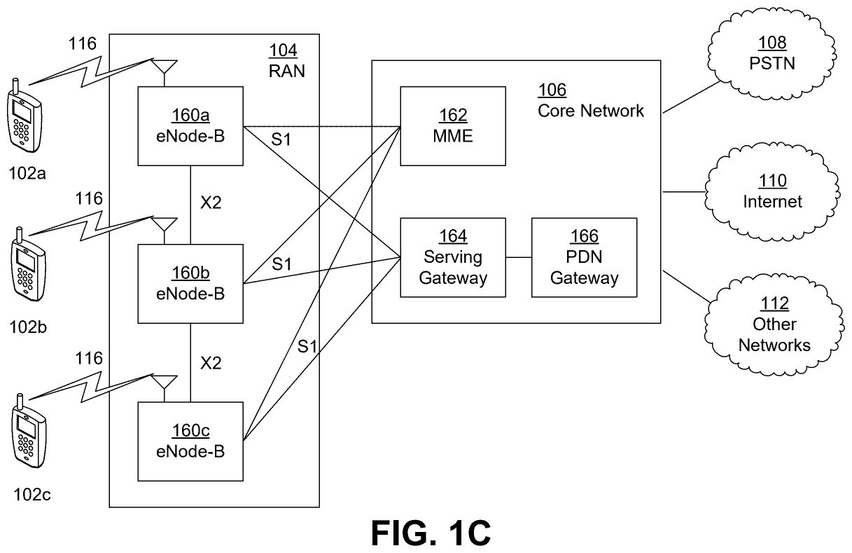

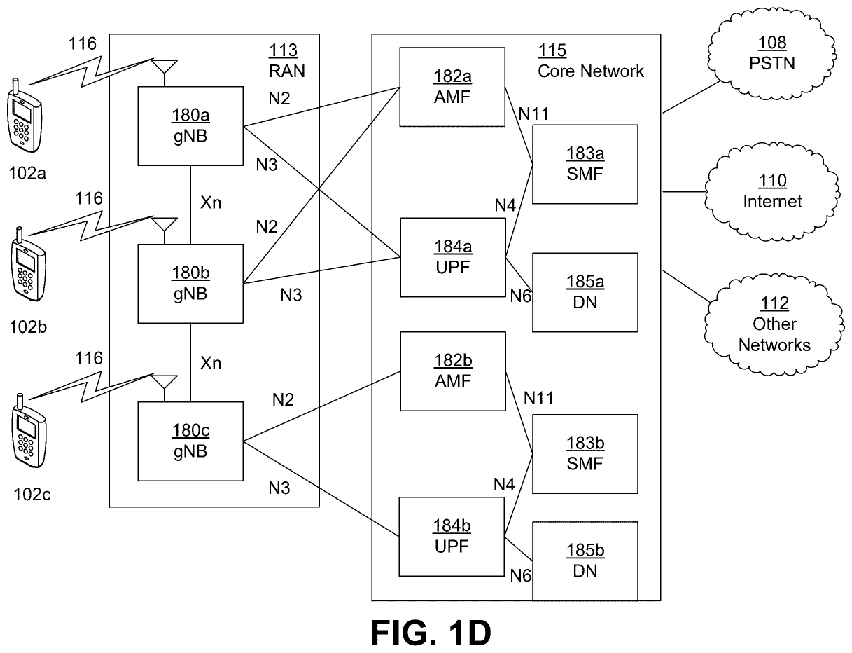

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to inactive/idle mobility enhancements based on predicted trajector(ies).

An example device may include a processor configured to perform one or more actions. For example, a device (e.g., a wireless transmit/receive unit (WTRU)) may send a predicted trajectory associated with the WTRU. The device may receive configuration information comprising a margin of error associated with a validity of the predicted trajectory. The device may enter a radio resource control (RRC) inactive state based on an indication to transition from an RRC connected state to the RRC inactive state. The device may determine, in the RRC inactive state, a deviation from the predicted trajectory. The device may determine the deviation is not within the margin of error. The device may send an indication (e.g., via a resume request message) based on the determination that the deviation is not within the margin of error. In examples, the resume request may comprise a cause value (e.g., a cause value that indicates a connection is being resumed for a trajectory update).

In examples, the device may receive an RRC resume message. The RRC resume message may indicate that a trajectory update is to be sent. The device may send the trajectory update that indicates one or more of: the deviation from the predicted trajectory; an updated trajectory; or an identity of the predicted trajectory.

In examples, the deviation may be a second deviation. The device may be (e.g., further) configured to determine a first deviation from the predicted trajectory. The device may determine that the first deviation is within the margin of error. The WTRU may remain in the RRC inactive state based on the determination that the first deviation is within the margin of error. In some examples, the device may refrain from performing a radio access network (RAN) update based on the determination that the first deviation is within the margin of error.

In examples, the device may be (e.g., further) configured to determine that the predicted trajectory has become invalid based on the determination that the deviation is not within the margin of error. The resume request may be sent based on the determination that the predicted trajectory has become invalid. In some examples, the device may send an indication that the predicted trajectory has become invalid.

In examples, the predicted trajectory may be a first predicted trajectory that may be associated with a first plurality of waypoints. The device may be (e.g., further) configured to determine a second predicted trajectory that is associated with a second plurality of waypoints. The device may compare the first plurality of waypoints with the second plurality of waypoints to determine the deviation from the first predicted trajectory. The device may determine a number of waypoints of the second plurality of waypoints that are different from the first plurality of waypoints. The determination that the deviation is not within the margin of error may be based on the number of waypoints being greater than a value.

In examples, the predicted trajectory may indicate that the WTRU is to traverse a first waypoint of the predicted trajectory at a first time. The device may be (e.g., further) configured to determine a probability for the WTRU to traverse the first waypoint at the first time. The determination that the deviation is not within the margin of error may be based on the probability being lower than a threshold.

In examples, the device may be (e.g., further) configured to determine the deviation from the predicted trajectory at a selected time interval.

In examples, the device may be (e.g., further) configured to indicate to a network that the WTRU is configured with a capability of predicting a trajectory associated with the WTRU. The device may determine the predicted trajectory associated with the WTRU. The predicted trajectory may be sent in a report to the network.

In examples, the configuration information may indicate the WTRU to transition from the RRC connected state to the RRC inactive state.

Examples are described pertaining to inactive/idle mobility enhancements based on predicted trajectory. Examples of procedures may include trajectory predictions/reporting and INACTIVE/IDLE state operation. For example, a device (e.g., a WTRU) may (e.g., be configured to) do one or more of the following actions. A WTRU (e.g., while in INACTIVE/IDLE state) may (e.g., be configured to) monitor changes between trajectory information/report (e.g., provided before/upon transition to INACTIVE/IDLE state) and current trajectory or/and predicted trajectory. A WTRU may (e.g., be configured to) trigger a connection resume/setup and/or inform the network about a trajectory change and/or expected/predicted trajectory change, for example, if the change of the current trajectory or predicted trajectory is more than a certain configured margin of error. A WTRU may be configured with multiple RAN areas. A (e.g., each) RAN area may correspond to a waypoint/time duration (e.g., or range of waypoints/time durations) that may have been reported in the WTRU's (predicted) trajectory report. A WTRU may update the RAN/Tracking area, for example, if/when the waypoint changes, e.g., without triggering RAN/Tracking area update.

Flight path reporting may occur in unmanned aerial vehicles (UAVs). Support for flight path reporting for aerial WTRUs (e.g., UAVs) may include (e.g., in NR and/or LTE), for example, a WTRU configured to include a flight path availability indication and/or a WTRU configured to include/indicate flight path availability in one or more messages, e.g., RRCReestablishmentComplete, RRCReconfigurationComplete, RRCResumeComplete, RRCSetupComplete, and/or UEAssistanceInformation message.

A UAV WTRU may be configured to send an indication that updates are available regarding previously reported flight path information, which may depend on, for example, one or more of the following: a new waypoint, which may not have been reported in a previous flight path report, may be available; a waypoint (e.g., previously reported) may be removed; a difference between a previously reported waypoint and a new waypoint may be more than a (e.g., configured) distance threshold; a timestamp may be available for a waypoint that may have been previously indicated without a timestamp; and/or a difference between a timestamp that may have been indicated for a waypoint and a new timestamp may be more than a (e.g., configured) time threshold.

A WTRU (e.g., if/when one or more of the conditions are fulfilled) may send (e.g., to a network) an indication in one or more messages (e.g., trigger a UEAssistanceInformation, or send the indication in an RRC complete message). A network may send a UEInformationRequest, which may indicate a flight path is requested. The WTRU may respond with a UEInformationResponse message, which may include the current flight path information. A flight path update may include some or all (e.g., the whole) flight path information, e.g., as opposed to updates from previously indicated flight path information.

A WTRU may be in a variety of RRC Connection states and/or may perform a variety of state transitions. RRC states that a WTRU (e.g., in NR) may be in may include, for example, one or more of the following RRC states (e.g., also referred to as modes): RRC_CONNECTED (e.g., also referred to as “CONNECTED mode”); RRC_INACTIVE (e.g., also referred to as “INACTIVE mode”); RRC_IDLE (e.g., also referred to as “IDLE mode”).

In RRC_CONNECTED, a WTRU may be actively connected to a network, e.g., with signaling radio bearers (SRBs) and/or data radio bearers (DRBs) established. A WTRU in RRC_CONNECTED may be able to receive Downlink (DL) data from the network (e.g., in a unicast fashion) and/or may be able to send Uplink (UL) data to the network. The mobility of the WTRU from one cell/node to another may be controlled by the network. The network may configure the WTRU to send measurement reports periodically and/or if/when certain conditions are fulfilled (e.g., a neighbor cell becomes better than a serving cell by more than a threshold). The network may (e.g., based on the reports) send the WTRU a handover command to move the WTRU to another cell/node. The network may (e.g., also) configure a conditional handover (CHO), where the WTRU (e.g., instead of sending of a measurement report) may execute a (e.g., (pre)configured) handover command if/when one or more conditions are fulfilled. The network may (e.g., also) send the WTRU a handover (HO) command without receiving a measurement report (e.g., based on implementation, such as a determination of the current location).

The network may send the WTRU to an RRC_IDLE state (e.g., if/when the WTRU has no data activity for more than a duration) to save the WTRU battery and/or to save network resources. The WTRU's context may be released at the Radio access Network (RAN), e.g., the base station (gNB), and/or (e.g., also) the Core Network (CN). The WTRU (e.g., while in RRC_IDLE) may camp at the best cell (e.g., the cell with the best signal level at the highest priority RAT and the highest priority frequency within the RAT), which may facilitate the WTRU establishing the connection via the camped cell if a need arises for the WTRU to transition back to the connected state. The WTRU may (e.g., also) monitor a downlink paging channel to detect for DL data arrival. The WTRU may initiate a connection setup/establishment procedure, for example, if the WTRU detects a paging from the network indicating an arrival of DL data and/or if the WTRU needs to send UL data. Switching the WTRU from IDLE to CONNECTED may involve Core Network (CN) signaling, e.g., since the WTRU's context may be released from the CN upon transitioning to IDLE.

The transition from IDLE to CONNECTED may involve significant signaling overhead, for example, because when the WTRU goes to IDLE mode, the WTRU's RRC context may be released (e.g., at the WTRU, RAN, and/or CN). The WTRU may be unknown at the RAN/CN level. Security may (e.g., also) be re-established and/or the WTRU may be reconfigured with DRBs and SRBs, for example, before UL/DL data transmission/reception may occur.

The RRC_INACTIVE state may mitigate the issue. In RRC_INACTIVE, the WTRU's context may be maintained at the CN. The WTRU may not release its context/configuration. Thus, the WTRU may be quickly brought up to the CONNECTED state without the need to involve the CN and fully re-configure the WTRU, which may greatly reduce the latency for the state transition and/or may (e.g., also) reduce the signaling overhead in the network. The WTRU may be configured with a RAN area (e.g., a group of cells). The WTRU may operate similar to IDLE state in the RAN area. The WTRU may inform the network (e.g., by initiating a RAN area update procedure), for example, if the WTRU performs a cell re-selection outside the RAN area. The WTRU's location may (e.g., thus) be known at a RAN area level. The arrival of DL data at the RAN for the WTRU may be communicated to the WTRU, for example, via RAN paging. The WTRU may initiate the RRC resume procedure, for example, upon the arrival of UL data, reception of RAN paging indicating a DL data, and/or the triggering of a RAN area update (e.g., due to cell re-selection outside the current RAN area or periodically, if periodic RAN area update is configured). The RRC resume procedure may not involve the CN, for example, if the cell where the WTRU was released to INACTIVE state is controlled by the same gNB as the target cell where the WTRU is resuming the connection.

Artificial Intelligence and Machine Learning (AIML) may be implemented (e.g., for NR). AIML mobility may support, for example, network triggered L3-based handover (e.g., handover triggered by the network based on information received by the WTRU, such as measurement reports). Information may include WTRU trajectory information that can be used by the network to optimize the HO of the WTRU (e.g., reserve resources at target cells/nodes on time, send the HO or CHO command to the WTRU on time, etc.).

A RAN area maintenance update procedure may be implemented for RRC_INACTIVE under a scenario where the WTRU's location may be expected to change while the WTRU is in RRC_INACTIVE, for example, to enable the RAN to (e.g., be able to) page (e.g., quickly page) the WTRU based on (e.g., upon) DL data arrival. Configuring a small RAN area may reduce the paging overhead but may increase the amount of signaling (e.g., and WTRU power consumption) due to frequent RAN area updates. On the other hand, configuring a large RAN area may increase the paging overhead but may reduce the amount of signaling (e.g., and WTRU power consumption). Paging overhead may also be associated with increased connection resumption time, for example, because the network may not page (e.g., all) the cells within the RAN area at the same time (e.g., the network may page in a stepwise fashion). In some examples, RAN area maintenance and update procedures may be suboptimal, for example, for a WTRU that is aware of its trajectory/flight path (e.g., a UAV) or that can predict its trajectory (e.g., to some level of accuracy).

A WTRU may (e.g., optimally) update a (e.g., predicted) trajectory while in an INACTIVE state. The WTRU may determine (periodically) whether a reported trajectory is valid, for example, based on a trajectory change margin/threshold.

In some examples, an INACTIVE WTRU may use a (e.g., predicted) trajectory as the RAN area.

A WTRU that follows a (e.g., predicted) trajectory that was reported to the network before going to INACTIVE (with a certain level of error) may not need to do RAN area updates. The WTRU may be paged (e.g., accurately) by the RAN. In examples, the WTRU may determine whether to perform an RAN area update based on a deviation from the reported trajectory. In examples, the WTRU may perform a RAN area update if a deviation from the predicted trajectory is not within the margin of error and refrain from performing the RAN area update if the deviation from the predicted trajectory is within the margin of error. In some examples, the WTRU may mute the RAN area update when an identified deviation is within the margin of error.

An INACTIVE/IDLE WTRU may be configured to trigger a trajectory update, for example, if/when the WTRU determines that its trajectory has changed or may be expected/predicted to change (e.g., by a certain margin) from the trajectory information that the WTRU may have reported/predicted before transitioning to INACTIVE state.

A WTRU may (e.g., be configured to) perform one or more of the following. A WTRU may Indicate to the network a capability to know/predict trajectory (e.g., based on an AIML model, deterministic trajectory of a UAV, etc.). A WTRU may send a (e.g., predicted) trajectory report. A WTRU may receive an indication (e.g., RRC Release message) instructing the WTRU to transition to RRC_INACTIVE state. For example, a WTRU may receive a configuration (e.g., RRC Release, SIB, etc.) related to trajectory update triggering while in INACTIVE state (e.g., margin of error from reported path). The WTRU may determine, in the RRC inactive state, a deviation from the predicted trajectory. For example, a WTRU (e.g., while in RRC_INACTIVE) may monitor the difference between a trajectory (e.g., the current/predicted location/trajectory of the WTRU) and the reported trajectory (e.g., delta between reported location at that time vs actual location). The WTRU may determine the deviation is not within the margin of error. For example, a WTRU (e.g., upon detecting a difference larger than the configured margin of error) may perform one or more of the following: send an RRC Resume Request (e.g., cause value: trajectory update); receive an RRC Resume message; send the updated trajectory (or the delta/divergence from the previous reported trajectory); and/or receive an RRC Release and transition back to INACTIVE state). In some examples, the WTRU may be configured to determine a deviation from the predicted trajectory. The WTRU may determine that the first deviation is within the margin of error. The WTRU may remain in the RRC inactive state and/or determine not to perform an RAN area update, based on the determination that the first deviation is within the margin of error.

In some examples, a (e.g., predicted) trajectory/waypoint(s) may be associated with different RAN areas.

Multiple RAN areas may be configured that correspond with a reported trajectory, which may minimize RAN area/tracking area update signaling.

An INACTIVE/IDLE WTRU may be configured with multiple RAN areas. A (e.g., each) RAN area may correspond to a waypoint (e.g., or range of waypoints) that may have been reported in the WTRU's (e.g., predicted) trajectory report. A WTRU may update the RAN/Tracking area, for example, if/when the waypoint changes, e.g., without triggering RAN/Tracking area update.

A WTRU may (e.g., be configured to) perform one or more of the following. A WTRU may indicate to the network a capability to know/predict trajectory (e.g., based on an AIML model). Capability information may include, for example, time/duration of day for prediction, prediction time horizon, number of cells that can be predicted, confidence of prediction, etc. Capability information may include, for example, one or more (e.g., several) sets of information, e.g., one set for each AIML model. A WTRU may receive a configuration from the network to send a trajectory report/update. A WTRU may receive an indication (e.g., RRC Release message) instructing the WTRU to transition to RRC_INACTIVE state. For example, a WTRU may receive a configuration (e.g., RRC Release, SIB, etc.) of multiple RAN area configurations. A (e.g., each) RAN area configuration may correspond to a waypoint/timestamp (e.g., or range of waypoints or/and timestamps). The WTRU may be configured to prioritize cells within the current RAN area for cell re-selection. A WTRU may update the RAN area according to the current waypoint/timestamp and/or the associated RAN area configuration (e.g., without triggering a RAN area update). A WTRU (e.g., upon re-selecting to a cell outside the current RAN area) may send a RAN area update to the network. A WTRU may initiate a connection resume/setup to the currently selected cell (e.g., by sending the RRC resume request, etc.), for example, if/when conditions for connection resumption/setup are fulfilled (e.g., paging received, UL data available to be sent, RAN area update needed, etc.). For example, a WTRU may include an indication indicating whether the trajectory information is still valid or not, and/or may include updated trajectory information.

Terminology and components are described herein. The terms AI/ML and AIML may be used interchangeably. The terms “data,” “measurements,” “report,” and “results” may be used interchangeably. The terms starting conditions and validity conditions may be used interchangeably. The terms indication, information, and message may be used interchangeably. The terms “current cell,” “serving cell,” “source cell,” and “current camping cell” may be used interchangeably. The terms “target cell” and “candidate cell” may be used interchangeably. The terms “flight path” and “trajectory” may be used interchangeably. The terms “trajectory report” and “trajectory information” may be used interchangeably. The terms “waypoint” and “location” may be used interchangeably. The term msg1 may be used to refer to a UL message that carries a random access preamble. The term msg2 may be used to refer to a DL message that carriers a random access response (RAR) that may contain a timing advance (TA) and WTRU identity information. The term msg3 may be used to refer to a connection resume or setup request message from the WTRU to the network (e.g., RRCResumeRequest or RRCSetupRequest). The term msg4 may be used to refer to a response from the network to a connection resume or setup message from the WTRU (e.g., RRCResume or RRCSetup). The term msg5 may be used to refer to a (e.g., complete) message to the connection resume or setup (e.g., RRCResumeComplete or RRCSetupComplete).

Example descriptions herein are not limited to UAV type WTRUs (e.g., examples are applicable to any WTRU that can determine or predict its trajectory for a given time duration).

Although example descriptions may be pertain to prediction based on AIML models, the examples are equally applicable to any other form of prediction that doesn't use AIML (e.g., time series forecasting, interpolation methods, etc.).

Examples described herein are equally applicable to deterministic cases where the WTRU may not make predictions but may know (e.g., within a given lead time) what the flight path is going to be (e.g., for some time duration). For example, a WTRU may be a UAV that can receive instructions from a command center regarding its subsequent/upcoming flight path, a UAV device that can autonomously change its path to avoid collisions, etc.

Examples described herein are agnostic to the kind of AIML model/technique used by a WTRU (e.g., the algorithm used, the mechanism, such as a neural network or what kind of neural network, e.g., depth and/or parameters/weights of the network, etc.), the origins of the model (e.g., WTRU vendor, operator, network vendor, etc.), or how/where the training of the model is done (e.g., the input data used for the training, where the training is performed, if the training is performed offline or online, etc.). In some examples, a model may be trained based on historical observation of one or more flight paths (e.g., a WTRUs' actual flight path) in different WTRU conditions (e.g., during certain time durations of the day, during certain days of the week, at different locations/areas, different WTRU mobility patterns/speeds, etc.).

In RRC_INACTIVE, a WTRU's context may be maintained at the CN. The WTRU may not release its context/configuration.

A WTRU (e.g., during connection resume) may (e.g., first) perform a random access (RA) procedure (e.g., also referred to as a Random Access Channel (RACH) procedure), for example, before sending the RRCSetupRequest and/or the RRCResumeRequest message. The RA procedure may serve one or more purposes, such as one or more of the following purposes: acquire UL synchronization between the WTRU and the network (e.g., gNB); and/or obtain the resources that may be used for the sending of the request message.

A WTRU (e.g., during the RA procedures) may send a message on the RACH (e.g., referred to as msg1), which may include a Preamble and/or a Random Access—Radio Network Temporary Identifier (RA-RNTI) to the gNB. The preamble may be randomly selected out of a set of possible preamble values for example, in the case of a contention based random access (CBRA). For example, there may be a contention if another WTRU initiates a random access procedure using the same preamble value. A (e.g., specific) preamble may be provided to the WTRU beforehand (e.g., when the WTRU is in CONNECTED state, during the transition to the IDLE/INACTIVE state, etc.), for example, in the case of a contention free random access (CFRA). The RA-RNTI may be calculated, for example, based on the physical RACH PRACH) occasion at which the random access message may be sent to the network.

The gNB (e.g., upon receiving msg1) may respond with msg2, which may include a Random Access Response (RAR). The WTRU may receive the RAR. The network may (e.g., also) send a DCI (Downlink Control Indicator) in the PDCCH (e.g., scrambled with the RA-RNTI), which may be used by the WTRU to determine on which resources (e.g., time and frequency) the RAR (e.g., and other related information) is provided to the WTRU. The WTRU may try to detect the DCI within a period of time after sending the preamble (e.g., known as an RAR-window). The WTRU may retransmit the preamble again, for example, if the DCI is not received. The WTRU (e.g., if the WTRU receives the DCI) may receive the RAR at the indicated time and frequency resources in the PDSCH. The RAR and/or associated information may provide the WTRU with a timing advance (TA) to apply for sending UL data, a temporary Cell RNTI (TC-RNTI), and/or UL resources to send the setup/resume request message.

The WTRU may receive the detailed information/configuration regarding the usage of the random access channel (e.g., RACH occasion, random access response window, etc.), for example, via a (e.g., dedicated) configuration while in CONNECTED state, upon transitioning during an IDLE/INACTIVE state, and/or from a system information broadcast (SIB).

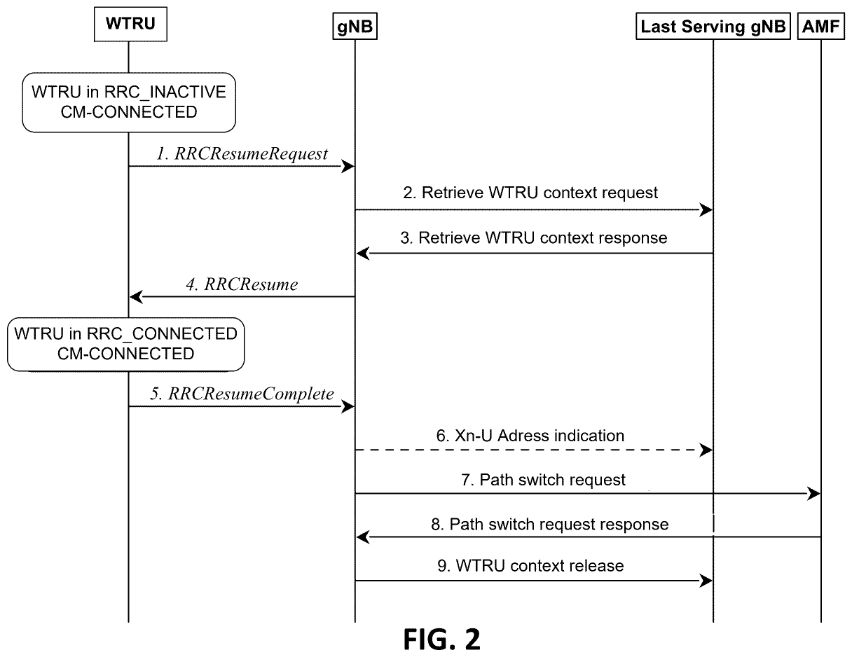

FIG. 2 illustrates an example of a state transition between INACTIVE and CONNECTED states. The CN may not be involved, for example, if the WTRU resumes within the cells that belong to the same gNB as where the WTRU went to INACTIVE.

A network (e.g., if/when the WTRU is sent to INACTIVE state) may include in the RRCRelease message a suspendConfig. The SuspendConfig may include information, such as, for example, one or more of the following: a resumeIdentity; a RAN paging area; and/or a nextHopChaining count.

A resumeIdentity may be used by the WTRU upon connection resume (e.g., to be included in the RRCResumeRequest message).

A RAN paging area (e.g., list of cells) may be the RAN area where the WTRU can be paged at RAN level. A WTRU may perform a RAN area update procedure, for example, if the WTRU performs cell re-selection to a cell outside the RAN area. A WTRU may (e.g., also) be configured to send a RAN area update procedure (e.g., periodically).

A nextHopChaining count may be used, for example, for deriving the security context (e.g., encryption/integrity protection keys) upon resuming the connection.

The WTRU may perform a connection setup/establishment or resume procedure. The WTRU (e.g.,) may include (e.g., in the RRCSetupRequest or RRCResumeRequest), the establishment or resume cause, respectively. Causes may include, for example, one or more of the following causes:

| | |
|---|---|
| EstablishmentCause ::= | ENUMERATED { |
| | emergency, highPriorityAccess, mt-Access, mo-Signalling, |
| | mo-Data, mo-VoiceCall, mo-VideoCall, mo-SMS, |
| | mps-PriorityAccess, mcs-PriorityAccess,spare6, spare5, |
| | spare4, spare3, spare2, spare1} |
| ResumeCause ::= | ENUMERATED {emergency, highPriorityAccess, mt-Access, mo-Signalling, |
| | mo-Data, mo-VoiceCall, mo-VideoCall, mo-SMS, rna-Update, |
| | mps-PriorityAccess,mcs-PriorityAccess, |
| | spare1, spare2, spare3, spare4, spare5 } |

For example, a connection may be setup/resumed due to a voice call or video call originating from the WTRU. The WTRU may (e.g., based on a WTRU-originated voice or video call) set the establishment/resume cause to mobile originated voice call (mo-VoiceCall) or mobile originated video call (mo-VideoCall). In some examples, a connection may be setup/resumed due to downlink paging indicating DL data. The WTRU may (e.g., based on downlink paging) set the establishment/resume cause to one of mobile terminated access (mt-Access), highPriorityAccess, mps-PriorityAccess, or mcs-PriorityAccess (e.g., depending on the access category of the WTRU).

The mechanism used for a RAN area update may be referred to as a “2 step resume” procedure, for example, because the WTRU may send a ResumeRequest indicating a cell re-selection outside the RAN area. The network may respond with a Release message (e.g., including a new RAN area configuration). The WTRU may remain in INACTIVE state. The network may have information in which RAN area the WTRU can be accessible, for example, if there is a need to page the WTRU (e.g., arrival of DL data at the RAN that is intended for the WTRU).

In some examples, there may be WTRU capability communication between the WTRU and the network about the WTRU's capability to know its trajectory and/or capability to do the trajectory prediction (e.g., using an AIML model). For example, the WTRU may indicate to the network the supported AIML models/functions for trajectory prediction, confidence level of predictions, time horizon of predictions (e.g., how far along in the future are the prediction being made), etc. For example, the WTRU may indicate that it is capable of trajectory prediction (e.g., as part of WTRU radio capability reporting, WTRU positioning capability reporting, etc.). WTRU capability communication may be triggered, for example, by the WTRU autonomously and/or based on a (e.g., an explicit) request from the network.

A WTRU may support one or more (e.g., several) AIML models for trajectory prediction (e.g., with different prediction time horizons, prediction confidence levels, processing requirements, trained under/for operation in different frequencies/cells/location/times of day, etc.). The WTRU may provide the support information/details, for example, as part of an (e.g., initial) AIML trajectory prediction capability reporting and/or on other (e.g., subsequent) messages. The models may be associated with different model IDs (e.g., global model ID, a local model ID assigned by the WTRU or the gNB that may be applicable at the cell level, gNB level, CN level, etc.).

An AIML model may operate in different modes (e.g., with different levels of prediction confidence levels at different prediction time horizons, at different locations, frequencies, WTRU mobility pattern/speed, etc.).

AIML models may be available at or provided to the WTRU already trained, and/or the WTRU may be provided with an untrained AIML model that the WTRU may train.

An AIML model may be available at the WTRU already trained. The WTRU may be enabled/configured to perform further training (e.g., for different conditions, such as frequencies/cells/location/times of day, for the same conditions as the initial training but for different (increased/decreased) levels of confidence or/and the prediction time horizon, for different WTRU speeds, etc.).

An AIML model may be available at the WTRU, but may not be trained at all or may be partially trained (e.g., trained for only certain WTRU/network conditions). The WTRU may (e.g., be configured to) train the model (e.g., for the conditions that it is not trained for).

In some examples, a WTRU may request/receive (e.g., require) one or more (e.g., some) configurations/inputs that the WTRU may use for performing an inference using an AIML model. In some examples, the WTRU may communicate the (e.g., required) configuration/input as part of the capability information. In some examples, the (e.g., required) configuration/input may be communicated to the network after a capability request, for example, based on a (e.g., an explicit) network request. A WTRU may request/receive a configuration/input, for example, if the WTRU is configured to do AIML based operations and determined that the WTRU is lacking a (e.g., required) configuration/input.

For example, the WTRU may be capable of doing radio measurement prediction (e.g., cell/beam level measurement prediction of serving and neighbor cells), while the WTRU may not be capable of (e.g., directly) predicting trajectories. The WTRU (e.g., after sending WTRU capability information to the network) may be provided with a configuration on how to transform the measurement predictions to trajectory predictions (e.g., signal level thresholds to indicate whether the WTRU is in the coverage of a certain cell or not, etc.). The WTRU may (e.g., then) perform the measurement predictions. The WTRU (e.g., based on the predictions and the received configuration) may transform the measurement predictions into trajectory predictions (e.g., at cell level granularity). The WTRU may send the (e.g., trajectory prediction) information to the network.

Life Cycle Management (LCM) is a term that may be used to describe the (e.g., overall) management aspects of AI/ML models, such as, for example, one or more of the following: model training; functionality/model identification; model delivery/transfer; model inference operation; functionality/model selection, activation, deactivation, switching, and/or fallback operation (e.g., a decision by the network, such as a network initiated or WTRU-initiated request to the network, a decision by the WTRU, such as an event-triggered decision, which may be configured by the network, WTRU's decision reported to the network, and/or WTRU-autonomous with the WTRU's decision reported to the network or without reporting the decision); functionality/model monitoring; model update; WTRU capability; and/or data collection (e.g., for model training, for monitoring, for inference, etc.).

LCM may be, for example, functionality-based LCM or model-ID based LCM.

Functionality-based LCM may include network indication(s) of activation/deactivation/fallback/switching of AI/ML functionality, for example, via signaling (e.g., RRC, MAC-CE, DCI). Models may not be identified at the network. The WTRU may perform model-level LCM. The WTRU may have one or more (e.g., multiple) AI/ML models for the functionality.

Model-ID-based LCM may include models, which may be identified at the network. The Network/WTRU may activate/deactivate/select/switch (e.g., individual) AI/ML models, for example, via model IDs.

A WTRU (e.g., in a functionality based LCM) may choose the AIML model to use for a (e.g., certain) functionality. For example, the network may decide for which functionalities the WTRU can use AIML based operation, and the WTRU may choose the AIML model to use.

A network (e.g., in a model-ID based LCM) may (e.g., explicitly) control which particular model may be used for a given AIML functionality. For example, the WTRU may provide details of AIML models and their capabilities, and the network may determine which model to activate for a particular functionality.

Examples described herein are applicable to model-ID based and functionality-based LCM. Example descriptions may relate to how the WTRU determines whether it has a model that is applicable for the indicated associated ID(s). For example (e.g., in the case of functionality-based LCM), the WTRU may be configured/requested to determine if a given functionality is valid/applicable. The WTRU may make the determination among (e.g., all) the models the WTRU has (e.g., for a given functionality). The WTRU may consider a functionality applicable, for example, if at least one of the models is applicable. In some examples (e.g., in the case of model-ID based LCM), the WTRU may be configured/requested by the network to determine whether one or more (e.g., particular) models are applicable or not.

An AIML functionality may be associated with a set of Key Performance Indicators (KPIs) or metrics. A KPI or metric may include, for example, prediction accuracy, average or mean square difference between measured and predicted values, etc. For example (e.g., for the trajectory prediction), a KPI or metric may be the location prediction accuracy or/and confidence level, the difference between the predicted and actual WTRU location or/and the time where the WTRU arrived at that location, etc. A WTRU may have one or more AIML models for a given functionality. A (e.g., each) AIML model may have performance levels that meet different KPI thresholds (e.g., WTRU may have two (2) models, where one model may have an accuracy level of 90% and another model may have an accuracy level of 95%, etc.). A WTRU may inform the network (e.g., during capability reporting or after the capability reporting) about AIML functionality associations.

Life Cycle Management (LCM) of the trajectory prediction models/functionality may or may not be an aspect in various implementations. In some examples, a WTRU may use a model (e.g., a certain model) for trajectory prediction that has been trained and performance tested. In some examples, one or more (e.g., some) LCM aspects may be enabled. For example, a frequent resumption of a connection to update a flight path (e.g., in contradiction with a previously indicated/predicted flight path) may be used by the network to determine that the accuracy of the flight path prediction is not good enough. The network may configure the WTRU to resort to an alternate configuration (e.g., a legacy RAN area configuration) and update. The WTRU may (e.g., also) be configured to monitor the accuracy of the predictions and/or to enable/disable the AIML based operation based on the performance (e.g., if the performance is below a configured threshold).

A smaller RAN area (e.g., one cell) may be configured with (e.g., very) little paging overhead. in some examples, however, a smaller RAN area may lead to excessive signaling as the WTRU may send a RAN area update every time the WTRU performs a cell re-selection. A larger RAN area (e.g., several cells in a large geographical area) may avoid the RAN area update overhead, but may be suboptimal from a paging point of view, e.g., as many cells may need to be paged before the WTRU can be reached. The network may reduce the paging overhead, for example, by implementing stepwise paging (e.g., paging a certain portion of the RAN area and page a different portion if no response is received from the WTRU, and so on). Stepwise paging may lead to delayed delivery of DL data or mobile terminated call setup.

As described herein, the network may have up to date information about the approximate location of the WTRU. The network may (e.g., easily) identify which cell(s) to page in case the WTRU has DL data, which may reduce the paging overhead/latency while (e.g., at the same time) reducing the (e.g., overall) UL signaling from the WTRU for updating the WTRU location (e.g., as long as the previously reported trajectory information is still valid within a certain margin of error).

WTRU context may be forwarded (e.g., in a timewise fashion) towards the most likely cells/gNBs (e.g., cells may be ready to resume the WTRU without the need to fetch context from the source gNB based on a Resume request).

Trajectory information (e.g., a trajectory) of a WTRU may include, for example, a list/series of locations/waypoints and estimated time that may be associated with the locations. The location information may have different levels of granularity. For example, (e.g., detailed) granularity may be at a GNSS x,y,z co-ordinates level or at a higher granularity, such as cell level information, e.g., cell identities such as PCI or GCI that the WTRU may be expected to be under the coverage of. The time information may be absolute time information (e.g., absolute time of the WTRU's expected arrival or departure at the corresponding location), relative time information (e.g., time difference from the arrival/departure time at a previous location or a pre-configured absolute time reference), or/and a time duration information (e.g., the duration the WTRU may be expected to be at the corresponding location). The time/location information may (e.g., also) be range of values (e.g., between location 1 and location 2, at times time 1 and time 2, etc.).

A confidence/probability level may be associated with a trajectory prediction. A confidence/probability level may be at a (e.g., whole) trajectory report level or at a (e.g., an individual) location/time level, e.g., for information included within the trajectory report. There may be multiple (e.g., separate) confidence levels for the location and time information.

The WTRU may provide multiple trajectory information, e.g., where each may be associated with different confidence levels (e.g., or sub confidence levels at the location/time pair level).

Trajectory information may be, for example, a series of time instances or time windows, multiple waypoints corresponding to a time instance/window (e.g., each time instance/window), and probability information indicating the likelihood of the WTRU being at the location at the corresponding time. Trajectory information may be, for example, as follows:
Time t1: [waypoint1_a:50%, waypoint1_b:30%, waypoint1_c:20%], Time t2: [waypoint2_a:30%, waypoint2_b:10%, waypoint2_c:30%, waypont2_d:30%], etc.

Trajectory information may include, for example, one or more of the following: a current location, direction of mobility, speed information, and/or validity time (e.g., current location x, traveling at 45 degrees in the NW direction at an average speed of x km/h, for the next x time duration).

Trajectory information may (e.g., also) include, for example, a set of direction and speed, e.g., each associated with one or more of the following: a time duration or range of time duration, a margin of error for the directions and speed, confidence levels for the direction and speed and/or a (e.g., one) confidence level for the (e.g., whole) trajectory, etc.

In some examples, there may be multiple possible trajectories for the WTRU (e.g., each with different confidence levels as described herein). The different trajectories may be assigned trajectory IDs.

A WTRU may (e.g., be configured to) report trajectory information while in CONNECTED state. A WTRU may report, for example, according to one or more of the following: based on a request (e.g., an explicit request) from the network (e.g., network sends a message such as message similar to a UEInformationRequest message, and the WTRU responds with a message similar to a UEInformationResponse message that includes the trajectory information); periodically (e.g., at a configured reporting periodicity, using a message similar to a UEAssistanceInformation (UAI) message); and/or based on a trigger, such as if/when there is a change from previously reported trajectory information (e.g., using a message similar to a UAI message). For example, a trigger may be based on a change in excess of (e.g., more than) a configured trajectory change threshold.

In some examples, the current trajectory of the WTRU (e.g., and the predicted trajectory, if the WTRU performs trajectory prediction) may be the same as a previously reported trajectory (e.g., or within some configured trajectory change threshold, as discussed herein). The WTRU may indicate (e.g., by sending a simple flag indicating) that the trajectory information that the network has available is still valid (e.g., in a UEInformationResponse message, in a UAI message, etc.).

In some examples, the trajectory information may change. The WTRU may send an update (e.g., immediately) or the WTRU may indicate that there is a change, which the WTRU may indicate in an update (e.g., only) upon (e.g., subsequent/explicit) request from the network.

A WTRU may determine a trajectory information change. A WTRU may be configured with trajectory change margin(s)/threshold(s) that the WTRU may use to determine whether the trajectory information the WTRU provided in a previous report can be considered to still be valid or not. In examples, the WTRU may be configured to determine that the trajectory information has become invalid based on a determination that a deviation from the trajectory information is not within a margin of error. A resume request may be sent based on the determination that the trajectory information has become invalid. The WTRU may send an indication that the trajectory information has become invalid. Trajectory change margins/thresholds (e.g., a margin of error for the deviation) may include one or more of the following.

Trajectory change margins/thresholds may be related to the waypoints that the WTRU has already traversed through (e.g., or may have indicated that the WTRU expects to traverse through before the current time).

Trajectory change margins/thresholds may be related to the waypoints that the WTRU has not traversed yet (e.g., but may have indicated that that the WTRU expects to traverse through at some point in the future).

Trajectory change margins/thresholds may be related to time durations before the current time.

Trajectory change margins/thresholds may be related to future time durations.

Trajectory change margin/thresholds may be a (e.g., certain) number of or percentage of waypoints. For example, a WTRU may consider the trajectory information to be invalid if the WTRU detected that it has not passed through a (e.g., certain) number of waypoints that the WTRU may have indicated it would traverse at the current time. For example, a WTRU may have indicated in a previous report that it will be at w1 in t1, w2 in t2, and w3 in t3. The WTRU may have noticed that it has skipped w2 and gone directly from w1 to w2. A WTRU may consider the trajectory information to be invalid, for example, if the WTRU determines/expects that it may not/will not pass through a certain waypoint that has previously reported to pass through in the future (e.g., based on new predictions, based on new flight path instructions received from a controller by a UAV device, UAV device changing its route due to collision avoidance, etc.).

A trajectory change margin/threshold may (e.g., also) be specified in terms of time or time duration change regarding a waypoint. For example, the WTRU may have indicated in the trajectory report that the WTRU expected to reach w1 at t1, but the WTRU reaches at w1 at t1+threshold1. The WTRU may consider that the trajectory information has changed, e.g., based on the difference in time duration exceeding threshold1. A window of time duration may (e.g., also) be configured. For example, the WTRU may arrive at w1 between t1−threshold1 and t1+threshold2. The WTRU may consider the trajectory information has not changed regarding the waypoint based on arrival at w1 between t1−threshold1 and t1+threshold2.

A trajectory change margin/threshold may be in terms of a relative/absolute distance change from a waypoint or one or more sets of waypoints.

A trajectory change margin/threshold may be in terms of relative/absolute change of direction of movement.

A trajectory change margin/threshold may be in terms of relative/absolute change of speed.

A trajectory change margin/threshold may be specified in terms of one or more confidence levels of future waypoints and/or time instances/durations. For example, a WTRU may indicate that it will reach a certain waypoint at a given time (e.g., or/and stay at the waypoint for a given time duration) with a confidence level of x % in a trajectory report, but later on the WTRU finds out the confidence level of the prediction has changed (e.g., by more than a certain/threshold percentage from the reported confidence level). The WTRU may consider the trajectory information has changed, for example, based on the change exceeding the threshold percentage.

In some examples, there may be a (e.g., one) confidence level associated with trajectory information (e.g., applicable to all the waypoints/time instances/windows, etc.). The trajectory change margin/threshold may be related to the confidence level.

In some examples, the trajectory information may include multiple trajectories, where, for example, each may be associated with a confidence level or probability (e.g., trajectory 1: 40%, trajectory 2: 30%, trajectory 3:30%) indicating the confidence/probability that the WTRU expects to follow each trajectory. The WTRU may determine that one or more of the probabilities have changed (e.g., by more than an absolute/relative threshold/percentage) based on, for example, one or more new predictions. The WTRU may consider the trajectory has changed based on the determined change of one or more probabilities (e.g., new trajectory information could be trajectory 1: 30%, trajectory 2: 50%, trajectory 3:20%).

A change of trajectory may be related to new information available at the WTRU future waypoints or timelines that were not included in a previous report. For example, a previously reported trajectory may concern a time duration up to T1. The WTRU may acquire new information regarding timeline T1 to T2 (e.g., at time t<T1), for example, based on a new prediction, based on new trajectory information provided to a UAV WTRU from a control center, etc. The WTRU may consider the trajectory information has changed and may trigger a trajectory information update based on the new information, e.g., even though the previous trajectory information may still be valid from now (t1) to T2.

A WTRU may provide a trajectory information update. A WTRU, having determined a trajectory information change (e.g., as described herein) may (e.g., be configured to) send a trajectory update report or an indication that the trajectory information has changed, which may be followed by sending the update (e.g., in response to a subsequent/explicit request from the network).

A WTRU may indicate (e.g., in the indication that the trajectory information has changed) whether the change is regarding past waypoints/time points and/or future waypoints/time points.

Updated trajectory information may be, for example, delta information or full information. Delta information (e.g., change from a previously sent report) may include, for example, one or more of the following: an indication to remove one or more waypoints; an indication to add one or more waypoints and associated time instances/durations, confidence levels, etc.; an indication to modify the time instance or time duration associated with an existing waypoint; an indication to modify the waypoint(s) associated with a time duration or time instance; and/or an indication to modify the confidence levels of a trajectory, one or more waypoint/time instance duration pairs, or one or more (e.g., specific) waypoints or times instance/duration (e.g., separately).

A request from the network to send the updated trajectory may include an indication indicating whether the WTRU is requested to send updated information regarding past waypoint/time points or/and future waypoints/timepoints. A request may be granular enough to indicate the type of update to be provided (e.g., indicate added waypoints, indicate removed waypoints, indicate waypoints whose time duration information has changed by more than a threshold, indicate waypoints that have been skipped, indicate waypoints or (e.g., whole) trajectories whose confidence level has changed by more than a certain percentage, etc.).

A WTRU may be configured to perform one or more actions on transition to INACTIVE state.

As described herein, a WTRU may be configured to do trajectory reporting and/or reporting of a change of a previously reported trajectory information while in CONNECTED state.

A WTRU may (e.g., also) be configured to trigger trajectory reporting upon transition to an INACTIVE state.

For example, a WTRU may receive an RRC Release message instructing the WTRU to transition to the INACTIVE state. The WTRU may (e.g., in response to the RRC Release message) check if the WTRU has trajectory information available (e.g., trajectory information the WTRU may not have sent in a trajectory report before) and/or check if trajectory information the WTRU sent needs to be changed (e.g., according to any trajectory change determination, as described herein). If so, the WTRU may send an indication that such a report is available or the WTRU may (e.g., immediately) send the report/update.

For example, an indication/flag may be included in the RRC Release message, instructing the WTRU to make a determination to report trajectory information (e.g., if available at that time, if the trajectory has changed from the previously reported trajectory, etc.).

The WTRU may perform an additional trajectory prediction upon receiving an RRC release message, e.g., to generate the trajectory prediction or to determine if a previously reported trajectory report is still valid.

In some examples, an RRC Release procedure may not provide for a response/complete message from the WTRU to the network. The indication/flag included in the RRC release message may be an indication to the WTRU that a response message is requested/required from the WTRU. For example, a WTRU may provide an RRC Release Complete message (e.g., including an indication that the trajectory information is still valid, including an indication the trajectory information has changed, or the updated/new trajectory information). The new or updated trajectory information may not need to be included in an RRC Release complete message. For example, a WTRU may send new or updated trajectory information using a WTRU Assistance information message or the WTRU may send an indication of the availability of updated/new trajectory information and wait for a UEInformationRequest from the network before sending the updated information using UEInformationResponse.

The information regarding the availability of new trajectory information, availability of an update to trajectory information, or a confirmation that previously reported trajectory information is still valid may be indicated to the network, for example, via lower layer signaling (e.g., a MAC CE), instead of an RRC message (e.g., RRC Release complete message).

The WTRU may (e.g., also) receive the trajectory change thresholds to be used in the INACTIVE state in the RRC Release message, the SIB, and/or in an RRC reconfiguration message before the RRC release message. For example, the WTRU may be configured with different thresholds in the INACTIVE state as compared to the thresholds used in CONNECTED state, as the trajectory requirements may be different for INACTIVE and CONNECTED WTRUs. For example, the network may be using the trajectory information for early preparation of target cells for handover and conditional handover in CONNECTED state. Errors in trajectory information in CONNECTED state may have more severe impacts (e.g., waste of network resources), for example, compared to the INACTIVE case operation, where the network may more easily compensate for a possible error in the WTRU's trajectory by paging the WTRU to one or more (e.g., a few) neighboring cells (e.g., in addition to the serving cell the WTRU may be expected to be at the time based on the trajectory information).

A WTRU may perform trajectory monitoring/prediction while in INACTIVE state. A WTRU may perform the monitoring of a change of trajectory information while in INACTIVE state (e.g., using a trajectory change determination mechanism described herein. A WTRU may use one or more configured thresholds for determining whether to make a trajectory update while in INACTIVE state. Thresholds configured for INACTIVE state may be the same as thresholds configured for the CONNECTED state, for example, if not (e.g., explicitly) specified otherwise.

A WTRU may (e.g., be configured to) perform trajectory change monitoring (e.g., only) for past waypoints/timelines and/or for future waypoints/timelines (e.g., based on new predictions).

A WTRU may (e.g., be configured to) perform trajectory monitoring in a periodic manner (e.g., perform the determination at least every x seconds). A configuration may be for setting the minimum requirements from the network point of view. The WTRU, e.g., if capable, may perform the monitoring and comparison with the thresholds more frequently than the configured periodicity. Periodicity may be part of the WTRU's capability (e.g., WTRU may indicate in the WTRU capability information on how often the WTRU is willing to do or can do the monitoring). Periodicity may be related to the processing/power requirements of doing trajectory predictions while in INACTIVE state. An objective of putting the WTRU in INACTIVE state may be power saving, so it may be undesirable to let the WTRU do AIML operations that utilize more power than putting the WTRU in CONNECTED state.

A WTRU may perform trajectory change reporting while in INACTIVE state. The WTRU may determine a trajectory information change while in INACTIVE state, e.g., as described herein. The WTRU in INACTIVE state may send an indication of the determined trajectory change to the network (e.g., by initiating the RRC resume procedure).

A WTRU may indicate that trajectory information has changed, for example, by using a (e.g., specific) RACH preamble when sending msg1 for triggering the RRC resume procedure. The WTRU may be configured with different RACH preambles that may provide more information about the change (e.g., a first preamble to be used if the change concerns past timelines or waypoints, a second preamble may be used if the change concerns future timelines or waypoints, and so on).

In the (e.g., msg2) response from the network (e.g., RAR), the network may indicate if the network is interested in getting more detailed information regarding the trajectory update. For example, the network may indicate that it is not interested in getting a trajectory update, and the WTRU may stop the resume procedure at that point (e.g., not send the resume request message).

The WTRU may (e.g., be configured to) send an indication that the trajectory information has changed, for example, by using a (e.g., specific) resume cause value in RRCResumeRequest/msg3 (e.g., cause value: trajectory_update). Different resume causes may be specified regarding whether the trajectory update pertains to past waypoints/timelines, future waypoints/timelines, or both past and future waypoints/timelines.

A WTRU may (e.g., be configured to) send more information regarding the trajectory change in a message (e.g., msg 3), for example, in addition to the resume change. For example, the WTRU may provide multiple trajectories in the trajectory report before/upon transitioning to the INACTIVE state (e.g., each with a trajectory ID). The WTRU may (e.g., also) indicate the most probable/likely trajectory (e.g., ID=x). The WTRU may determine that the trajectory has changed or is expected to change to another trajectory (e.g., ID=y). The WTRU may (e.g., directly) indicate the ID of the new trajectory to be used/assumed by the network, for example, in the resume request message.

A WTRU may be provided with multiple resume identities to include in the resume request (e.g., each corresponding to different information about the trajectory change), for example, instead of or in addition to cause values or extra information elements that may be added to the resume message. For example, the WTRU may have been provided with resume identity A if the WTRU is resuming due to a change of past waypoints/timelines, resume identity B if the WTRU is resuming due to a change of future waypoints/timelines, resume identity C if the WTRU is resuming due to a change of both past and future waypoints/timelines, etc.

The WTRU may receive a Release or a Resume message in response to the ResumeRequest message. For example, the WTRU may receive an RRCResume message indicating for the WTRU to send the detailed trajectory update information or the delta trajectory update, which the WTRU may perform, for example, by including the information in the RRCResumeComplete message (e.g., or by using another message, such as the UEAssistanceInformation, that may be sent after the resume complete message or along with the resume complete message). The information may (e.g., also) be a lower layer message, such as a MAC CE that may be multiplexed with the RRCResumeComplete message.

Multiple RAN areas may be associated with a trajectory. A WTRU may have provided trajectory information (e.g., as described herein) while in CONNECTED state. The information may be used by the network to provide the WTRU with more optimal/precise RAN area configurations.

In some examples, a WTRU may be provided (e.g., in RRC Release, SIB) with multiple RAN area configurations.

A WTRU may be provided with a RAN area configuration that may be associated with a waypoint/time instance/duration.

A WTRU may be provided with a RAN area configuration that may be associated with a range of waypoints/time instances/durations.

A WTRU may be provided with a RAN area configuration that may be associated with a (e.g., one) given trajectory. The network may configure with a different RAN area configuration for a (e.g., each) trajectory, for example, if the WTRU has provided multiple possible trajectories.

In some examples, the network may have used the trajectory information provided by the WTRU to determine the multiple RAN area configurations. In some examples, the network may use trajectory information that it has about the WTRU without getting the information from the WTRU. For example, the trajectory information may be provided by an AIML model at the network that does the trajectory prediction for the WTRU, e.g., based on historical observations of the user's mobility pattern.

A WTRU may be configured to update the RAN area it uses (e.g., without sending a RAN area update), for example, according to the configured RAN area to waypoint/time association. For example, the WTRU may apply/use a first RAN area configuration associated with a first time duration T1 from the time the WTRU transitioned to INACTIVE state to time T1, the WTRU may apply/use a second RAN area configuration associated with a second time duration from T1 to T2, and so on. Similarly, the RAN area configuration may be changed based on the current waypoint of the WTRU and the associated RAN area for the waypoint.

The WTRU may (e.g., be configured to) consider both the previous and current update RAN area configurations to be valid for a certain time duration before (e.g., completely) switching to the new RAN area configuration. For example, the WTRU may be configured with time duration 1: RAN area config1, time duration 2: RAN area config2, time duration 3: RAN area config3, etc. During the start of time duration 2 (e.g., for a configured overlap/delta time) the WTRU may consider the RAN area to be a union of RAN area 1 and RAN area 2. The WTRU may consider the RAN area to be (e.g., only) RAN area 2, for example, (e.g., only) after the delta time has elapsed. Similarly, the WTRU may consider the RAN area to be a union of area 1 and area 2 for a delta duration before the start of time duration 2. A combination of these examples may be implemented, for example, where the WTRU may consider the RAN area to be the union of the two RAN areas between a delta time before and after the start of time duration 2. Such an overlap time between the different RAN areas may compensate for an error of the trajectory (e.g., if the WTRU arrives at a waypoint before the anticipated time, if the WTRU overstays at a waypoint, etc.).

A WTRU may be configured to perform cell re-selection and a RAN area update procedure. For example, a WTRU may (e.g., whenever the WTRU does cell re-selection) check if the selected cell is within the current RAN area and, if not, trigger a RAN area update.

A WTRU may be configured to prioritize cell re-selection to the cells within the current RAN area. For example, the WTRU may be provided with an offset to add to the signal levels of cells that belong to the current RAN area (e.g., or an offset to subtract from the signal levels of cells not belonging to the current RAN area) upon doing the cell ranking for cell re-selection.

Cell reselection prioritization may (e.g., also) be more aggressive. For example, a WTRU may select/camp on a cell with a signal level above a (e.g., threshold/certain) level within the anticipated RAN area (e.g., even if there are better cells available outside the RAN area).

Cell reselection prioritization may (e.g., also) be towards cells the WTRU has indicated that may expected to be in a trajectory report previously provided to the network at a particular time or time duration (e.g., if trajectory report was at cell level).

A WTRU may perform connection resumption (e.g., due to UL data arrival, RAN paging received due to DL data arrival). The WTRU may be camping on a cell that was prioritized (e.g., as described herein). The WTRU (e.g., if the WTRU was camping on a cell that was prioritized) may (e.g., be configured to) perform a cell re-selection to determine the best cell at the time (e.g., within or outside the current RAN area). The WTRU may perform the connection resumption on the determined best cell (e.g., by sending msg1 towards/on the cell). The WTRU may (e.g., alternatively) not do additional cell re-selection and start the resumption on the current cell. The WTRU may indicate to the network that the cell the WTRU is resuming from is not the best cell (e.g., using a specific RACH preamble, using a new resume cause value, using a new information element included the resume request or resume complete message, etc.). For example, the indication may (e.g., further) indicate information regarding the identity of the best cell. The network may use the information regarding the identity of the best cell to reconfigure/HO the WTRU to the best cell (e.g., immediately) after the connection resumption.

The WTRU may (e.g., also) be configured to camp on multiple (e.g., two) cells, which may include a first cell according to cell re-selection criteria without any prioritization due RAN area (e.g., described herein) and a second cell according to the prioritization (e.g., as described herein). For DL data, the WTRU may be likely to receive the paging via the second cell (e.g., because the second cell is the cell the network may expect the WTRU to be camped on due to the trajectory information the WTRU provided earlier). The WTRU may be monitoring the paging channel of (e.g., only) the second cell. The WTRU (e.g., upon reception of paging over the second cell) may trigger the connection resumption over the first cell. The WTRU (e.g., upon arrival of UL data) may (e.g., also) trigger the resumption via the first cell. An advantage of camping on two cells (e.g., compared to another example described herein) may be that the WTRU doesn't need to do further cell re-selection (e.g., because the WTRU already knows the best cell to be used for resuming the connection but the WTRU doesn't reselect to the best cell to avoid triggering a RAN area update to the network, and the WTRU is also monitoring the paging of the second cell to avoid missing any paging for DL data).

A WTRU may (e.g., further) be configured to check/monitor a change in trajectory information, which may trigger a trajectory update (e.g., as described herein). The WTRU may be configured to perform the monitoring in a more relaxed manner, e.g., at longer periodicity, using larger trajectory change thresholds, etc., for example, since the multiple tracking area association for each waypoint/time duration or range of waypoints/time duration may be compensating for a level of trajectory error from the WTRU.

A WTRU may be configured to trigger the RAN area update. The WTRU (e.g., once the RAN area update is triggered) may send information regarding a possible trajectory change (e.g., of past waypoints/timelines, future waypoints/timelines, etc.), for example, as described herein.

Although examples provided herein may pertain to INACTIVE state operation, the examples are equally applicable to IDLE state operation. For example, in IDLE mode, a WTRU may be configured with a tracking area, registration area, PLMN, etc. When the WTRU goes outside of the area, the WTRU may initiate a tracking area or a registration area update procedure. Similar to the INACTIVE state, the (predicted) trajectory information of the WTRU may be used instead of the registration area to locate and page the WTRU more efficiently. Similarly, on the WTRU side, examples described herein may be applied (e.g., trajectory update while in IDLE state, multiple tracking areas assigned with different waypoints or sets of way points, etc.). For example, the WTRU may trigger a connection setup procedure. The WTRU may indicate that the trajectory information has changed in msg1, msg3 (e.g., RRCSetupRequest, for example, with a new establishment cause value), msg 5 (e.g., RRCSetupComplete), etc.

During normal resume (e.g., due to UL or DL data), the WTRU may (e.g., also) be configured to indicate trajectory change information (e.g., as described herein). The WTRU (e.g., even if the resume is being triggered due to UL/DL data) may inform the network if the trajectory information is still valid or needs updating, e.g., in an additional information element (IE) in the resume request or complete messages, for example, by (e.g., immediately) triggering a separate message, such as WTRU assistance information (e.g., immediately) after the resume complete, etc.

Examples described herein may co-exist with other (e.g., legacy) RAN area configuration and update procedures. For example, the WTRU may be configured with legacy RAN area (e.g., large RAN area), e.g., to ensure that the WTRU may still get paged in case the trajectory update information becomes invalid. The network may try to page the WTRU in a smaller number of cells that correspond with the trajectory information reported by the WTRU. If a response is not received from the WTRU within a (e.g., certain/threshold) time, the network may page the WTRU at the configured RAN area level.

A WTRU may provide multiple trajectories (e.g., with different probabilities), for example, as described herein. The network may (e.g., if the WTRU provided multiple trajectories) decide to page the WTRU to the cells that the network expects the WTRU to be on (e.g., according to the trajectory with the highest probability). If the WTRU doesn't respond within a (e.g., given/threshold) time, the network may page the WTRU to the cells according to the trajectory with the next highest probability, and so on.

A WTRU may indicate (e.g., instead of a trajectory update) that trajectory information is invalid/unreliable. The WTRU may indicate (e.g., implicitly or explicitly) that the WTRU wants to resort to alternative (e.g., legacy) operations (e.g., via RAN area configurations). The WTRU may provide the indication to the network, for example, with a new resume cause value, a new information in the resume request message, in the resume complete message, etc. For example, the resume cause value may be a trajectory update, but detailed information about causation indicating why the trajectory is invalid may be provided in a subsequent message (e.g., resume complete, an RRC message, such as WTRU Assistance information, or a lower layer message, such as MAC CE).

For example, the WTRU may be configured with thresholds regarding how many or what percentage of inaccurate/wrong waypoint/time duration detection may invalidate a trajectory. The WTRU may determine, e.g., by comparing current waypoints and current times with the waypoint/time that was indicated in the trajectory information provided to the network, if more than the acceptable number/percentage of inaccurate/wrong waypoint/time duration detection has been made, the WTRU may send an indication that the trajectory information is in valid, for example, if the inaccuracy threshold has been passed.

For example, a determination of the validity of trajectory information may be based on more up to date predictions. A WTRU may send an indication to the network, for example, if the WTRU performs the prediction and determines that the confidence level is now lower than the confidence level indicated in the trajectory report that was earlier provided to the network.

A WTRU may traverse across a coverage hole, for example, even if the WTRU was moving as predicted/reported to the network. During a time duration in the coverage hole, it is possible that DL data may have arrived for the WTRU. The network may have paged the WTRU, but WTRU may have been unable to receive the page. The WTRU may be configured to inform the network that the trajectory information is still valid, for example, to avoid misinterpretation by the network of a coverage hole as invalid trajectory information. For example, the WTRU may indicate that the trajectory information is valid (e.g., as described herein), for example, by triggering the resume procedure. The WTRU may transition to IDLE state, for example, if the duration of the time the WTRU has stayed out of coverage exceeds a time threshold. The WTRU (e.g., if the WTRU transitioned to IDLE state) may inform the network by initiating the connection setup procedure and indicating the validity of the trajectory (e.g., as described herein, such as in msg1, in the RRCSetupRequest with a new cause value, in the RRCSetupComplete message, etc.).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
send a predicted trajectory associated with the WTRU;
receive configuration information comprising a margin of error associated with a validity of the predicted trajectory;
enter a radio resource control (RRC) inactive state based on an indication to transition from an RRC connected state to the RRC inactive state;
determine, in the RRC inactive state, a deviation from the predicted trajectory;
determine that the deviation is not within the margin of error; and
send an indication to a network based on the determination that the deviation is not within the margin of error.

2. The WTRU of claim 1, wherein the indication is sent via a resume request message, and the processor is further configured to:
receive an RRC resume message, wherein the RRC resume message indicates that a trajectory update is to be sent; and
send the trajectory update, wherein the trajectory update indicates one or more of the deviation from the predicted trajectory, an updated trajectory, or an identity of the predicted trajectory.

3. The WTRU of claim 2, wherein the resume request message comprises a cause value indicating a connection is being resumed for the trajectory update.

4. The WTRU of claim 1, wherein the deviation is a second deviation, and the processor is further configured to:
determine a first deviation from the predicted trajectory; and
determine that the first deviation is within the margin of error, wherein the WTRU remains in the RRC inactive state based on the determination that the first deviation is within the margin of error.

5. The WTRU of claim 1, wherein the deviation is a second deviation, and the processor is further configured to:
determine a first deviation from the predicted trajectory;
determine that the first deviation is within the margin of error; and
refrain from performing a radio access network (RAN) update based on the determination that the first deviation is within the margin of error.

6. The WTRU of claim 1, wherein the processor is further configured to:
determine that the predicted trajectory has become invalid based on the determination that the deviation is not within the margin of error, wherein the indication is sent based on the determination that the predicted trajectory has become invalid.

7. The WTRU of claim 1, wherein the predicted trajectory is a first predicted trajectory and is associated with a first plurality of waypoints, and the processor is further configured to:
determine a second predicted trajectory that is associated with a second plurality of waypoints;
compare the first plurality of waypoints with the second plurality of waypoints to determine the deviation from the first predicted trajectory; and
determine a number of waypoints of the second plurality of waypoints that are different from the first plurality of waypoints, wherein the determination that the deviation is not within the margin of error is based on the number of waypoints being greater than a value.

8. The WTRU of claim 1, wherein the predicted trajectory indicates that the WTRU is to traverse a first waypoint of the predicted trajectory at a first time, the processor is further configured to determine a probability for the WTRU to traverse the first waypoint at the first time, wherein the determination that the deviation is not within the margin of error is based on the probability being lower than a threshold.

9. The WTRU of claim 1, wherein the processor is further configured to determine the deviation from the predicted trajectory at a selected time interval.

10. The WTRU of claim 1, wherein the processor is further configured to:
indicate to the network that the WTRU is configured with a capability of predicting a trajectory associated with the WTRU; and
determine the predicted trajectory associated with the WTRU, wherein the predicted trajectory is sent in a report to the network.

11. The WTRU of claim 1, wherein the configuration information indicates the WTRU to transition from the RRC connected state to the RRC inactive state.

12. A method, comprising:
sending, by a wireless transmit/receive unit (WTRU), a predicted trajectory associated with the WTRU;
receiving configuration information comprising a margin of error associated with a validity of the predicted trajectory;
entering a radio resource control (RRC) inactive state based on an indication to transition from an RRC connected state to the RRC inactive state;
determining, in the RRC inactive state, a deviation from the predicted trajectory;
determining that the deviation is not within the margin of error; and
sending an indication to a network based on the determination that the deviation is not within the margin of error.

13. The method of claim 12, wherein the indication is sent via a resume request message, and the method further comprises:
receiving an RRC resume message, wherein the RRC resume message indicates that a trajectory update is to be sent; and
sending the trajectory update, wherein the trajectory update indicates one or more of the deviation from the predicted trajectory, an updated trajectory, or an identity of the predicted trajectory.

14. The method of claim 13, wherein the resume request message comprises a cause value indicating a connection is being resumed for the trajectory update.

15. The method of claim 12, wherein the deviation is a second deviation, the method further comprising:
determining a first deviation from the predicted trajectory; and
determining that the first deviation is within the margin of error, wherein the WTRU remains in the RRC inactive state based on the determination that the first deviation is within the margin of error.

16. The method of claim 12, wherein the deviation is a second deviation, the method further comprising:
determining a first deviation from the predicted trajectory;
determining that the first deviation is within the margin of error; and
refraining from performing a radio access network (RAN) update based on the determination that the first deviation is within the margin of error.

17. The method of claim 12, further comprising:
determining that the predicted trajectory has become invalid based on the determination that the deviation is not within the margin of error, wherein the resume request is sent based on the determination that the predicted trajectory has become invalid.

18. The method of claim 12, wherein the predicted trajectory is a first predicted trajectory and is associated with a first plurality of waypoints, the method further comprising:
determining a second predicted trajectory that is associated with a second plurality of waypoints;
comparing the first plurality of waypoints with the second plurality of waypoints to determine the deviation from the first predicted trajectory; and
determining a number of waypoints of the second plurality of waypoints that are different from the first plurality of waypoints, wherein the determination that the deviation is not within the margin of error is based on the number of waypoints being greater than a value.

19. The method of claim 12, wherein the predicted trajectory indicates that the WTRU is to traverse a first waypoint of the predicted trajectory at a first time, the method further comprising:
determining a probability for the WTRU to traverse the first waypoint at the first time, wherein the determination that the deviation is not within the margin of error is based on the probability being lower than a threshold.

20. The method of claim 12, further comprising:
determining the deviation from the predicted trajectory at a selected time interval.
